(19) United States
(12) Patent Application Publication
(10) Pub. No.: US 2021/0236974 A1
(43) Pub. Date: Aug. 5, 2021

(54) MIST ELIMINATOR

(71) Applicant: MUNTERS EUROFORM GMBH, Aachen (DE)

(72) Inventors: Juergen SCHMITZ, Aachen (DE); Peter WANDRES, Aachen (DE); Verena EICHHORN, Dueren (DE)

(21) Appl. No.: 17/054,825

(22) PCT Filed: May 11, 2019
(86) PCT No.: PCT/DE2019/000139

§ 371 Date: Nov. 12, 2020

(30) Foreign Application Priority Data
May 24, 2018 (DE) 10 2018 004 170.1

(51) Int. Cl. B01D 45/08

(52) U.S. Cl. CPC B01D 45/08

(57) ABSTRACT

A mist eliminator is described for separating liquid and/or solid particles out of a gas stream. The mist eliminator has various functional elements that are arranged in the gas stream direction in the gas stream path in three or more levels (5, 6, 7) of which the first level (5) comprises flow deflection elements (3) and the other levels (6, 7) each comprise liquid/solid particle collection and discharge elements (8, 9). The mist eliminator is characterized in that it has a particularly good separating efficiency with a low pressure loss and a small installation depth.

The present invention is directed to a mist eliminator for separating liquid and/or solid particles out of a gas stream and comprising a housing having an inlet for the gas stream carrying liquid/solid particles and an outlet for the gas stream stripped of the liquid and/or solid particles and for the liquid and/or solid particles, and a plurality of functional elements in a flow path of the gas stream carrying liquid/solid particles.

Mist eliminators for separating liquid/solid particles from a gas stream are known. For instance, it occurs with many technical applications that an air stream containing liquid drops and/or solid particles flows through a flow passage, and a separation of the liquid drops and/or solid particles, normally water drops, occurs by multiple deflection of the air stream. Here, the deflection of the gas stream is caused by functional elements of the mist eliminator that generate a serpentine flow path of the gas stream. The entrained liquid droplets and/or solid particles stick to the functional or separation elements and move from there into an outlet of the mist eliminator whence they are discharged.

A mist eliminator of the above-described kind is known from EP 0 281 981. In the direction of the gas flow path this mist eliminator has a first level of spaced flow deflection elements. Then a second level of liquid collection and discharge elements follows effecting the separation of the entrained liquid droplets that are fed from there into a duct and discharged from the eliminator. The flow deflection elements of the first level are of V-section while the liquid collection and discharge elements of the second level are of approximately of inverted-V-shape.

EP 1 059 107 describes a separator that includes an agglomerator having two rows of offset rods that are passed by a gas stream in a serpentine path.

It is the object of the present invention to provide a mist eliminator of the above-described type that is characterized by an especially good separation efficiency with a pressure loss as small as possible and with a small installation depth.

According to the invention this object is attained with a mist eliminator of the above-described type characterized by the features that the functional elements in the gas flow path in a flow direction are in three or more levels of which the first level in flow direction includes a plurality of juxtaposed and spaced pure flow deflection elements, the second level in flow direction and possibly further level has a plurality of juxtaposed and spaced first liquid/solid particle collection and discharge elements, and the last level in flow direction includes a plurality of juxtaposed and spaced further liquid/solid particle collection and discharge elements, whereby the offset functional elements partly overlap laterally with a covering region of a functional element, and the flow deflection elements of the first level as well as the first liquid/solid particle collection and discharge elements of the second and possibly further level have downstream faces extending in an inclined or curved manner toward center lines of the intermediate spaces between the functional elements of the next downstream level.

Accordingly, the inventive mist eliminator has at least three levels of functional elements arranged one after the other in the flow path of the gas stream carrying liquid/solid particles. The first level is formed by pure flow deflection elements that have nearly no separation and liquid/solid discharge function. The following levels have functional elements that are formed as liquid/solid particle collection and discharge elements, i.e. carry out the desired droplet/particle separation and discharge of the separated droplets/particles.

Accordingly, due to the invention at least two levels are provided for the liquid/solid particle separation so that here a multiple separation effect results. So that functional elements of the last level can carry out an efficient liquid/solid particle separation and discharge, it is provided according to the invention that downstream faces of the flow deflection elements of the first level and of the liquid/solid particle collection and discharge elements of the second and possibly further level take over corresponding guiding functions guiding the gas stream through the intermediate spaces between the functional elements of the second and possibly further levels into the separation or collection elements of the last level or between same. Accordingly, not only the functional elements of the second level and possibly further level but also the functional elements of the last level effect a liquid/solid particle separation and liquid/solid particle discharge. This way, an efficient separation is reached on the whole although the functional elements of the inventive mist eliminator are offset so that only a small blocking of the gas stream is provided. In other words, the gas stream passing the eliminator passes the same with only a slightly serpentine path. On the other hand the functional elements of the levels are arranged in such a manner that the gas stream cannot pass the eliminator in a straight line.

Accordingly, an efficient separation with a small pressure loss is obtained despite of the relatively small blocking provided according to the invention by the two separation stages arranged thereafter. This way, liquid drops can be separated that have preferably a dimension of 10-30 μm, especially 20 μm. Particularly, such a mist eliminator is suited as surge separator with which a sudden surge of liquid entrained in a gas stream can be eliminated in an efficient manner.

Preferably, the mist eliminator can be adapted to the diameter of the drops or particles to be separated by variation or adjustment of the spacings of the individual levels and functional elements of the mist eliminator.

In order to attain an efficient separation of the functional elements of the second and possibly further level and last level downstream faces of the flow deflection elements of the first level and the liquid/solid particle collection and discharge elements of the second and possibly further level take over corresponding flow guide functions guiding the gas stream through the intermediate spaces between the functional elements of the second and possibly further level and through the intermediate spaces between the functional elements of the last level wherein the entrained liquid drops and/or solid particles are intercepted by the functional elements of the different levels. Since the functional elements of the different levels overlap only slightly a small loss of pressure is generated. The functional elements of the first level designed as pure deflection elements accelerate the gas flow whereby the separation of the liquid and/or particles in the following levels is simplified.

Preferably, the downstream faces of the flow deflection elements and of the first liquid/solid particle collection and discharge elements are angled to center lines of the intermediate spaces between the functional elements of the next downstream level. In principle, these downstream faces can be formed in an inclined or curved manner if they only fulfil their guide function into the intermediate spaces of the next level. Here, a roof-like design of the downstream faces with a point formation is preferred that is directed toward the center line of the intermediate spaces. This does not exclude other embodiments. Arcuate designs can be used, too.

As regards the flow deflection elements of the first level, they are preferably formed with a rhombic section. Here, the flow impinging on the tip of the rhombus on the upstream side (flow side) is divided and is guided onto the two first adjacent liquid/solid particle collection and discharge elements of the second level of which the liquid drops and/or solid particles are intercepted and discharged. The gas stream released therefrom is fed along an inclined, preferably slightly curved, downstream face of the lozenge-section flow deflection element between the two functional elements of the second level through and impinges linearly onto the functional element of the next level where the remaining liquid drops and/or solid particles are separated and collected either. Then the gas stream is guided along a downstream face of the functional element of the second and possibly further level between the functional elements of the last level through to the outlet of the mist eliminator.

Accordingly, the lozenge-section flow deflection elements of the first level fulfil two functions: On the one side they direct the gas stream onto a functional element of the second level and accelerate them and on the other side they direct the gas stream deflected by the functional elements of the second level onto the corresponding functional element of the next level.

Preferably, the liquid/solid particle collection and discharge elements of the second and possibly further level and last level are formed as box-like collection elements open at the upstream side (flow side). According to another embodiment these functional elements have the shape of an inverted V. Generally, any shapes are possible if only a collection region for the liquid drops and/or solid particles to be separated is present and the corresponding downstream faces of these functional elements have the above-described guide functions.

So, for instance, the liquid/solid particle collection and discharge elements of the second and possibly further level can have a deflection elevation on their downstream faces that can be a small deflection ridge. Preferably, this ridge has an apex that is directed onto the center line of the intermediate space of the functional elements of the next level.

According to a special embodiment the downstream faces of the flow deflection elements of the first level are formed in a concavely curved manner. Furthermore, the flow deflection elements have preferably an opening angle of 60-120°, especially of 90°, on their upstream side (flow side).

Especially, the mist eliminator described here is designed as a small unit that can be especially used behind heat exchangers with cheap design. Examples are vehicle motors on the basis of fuel cells. Here, during the starting of the motor but also during the operation a pull-out of water drops from an exchange membrane can occur that can damage the blades of a turbine arranged downstream and can result in a failure of the same. This can be prevented by the inventive mist eliminator.

In order to design the mist eliminator as small as possible according to a special embodiment it is provided that a space for laterally deflecting the gas stream released from liquid or solid particles is present in the housing behind the last level. Accordingly, here the gas stream released from liquid or solid particles is laterally discharged from the housing.

Preferably, the mist separator is flown against horizontally and the separated liquid and/or solid particles are discharged by gravity downwardly or laterally. For this, a suitable duct construction can be provided.

In the following the invention is described with reference to an example in connection with the drawing in detail. In the drawing

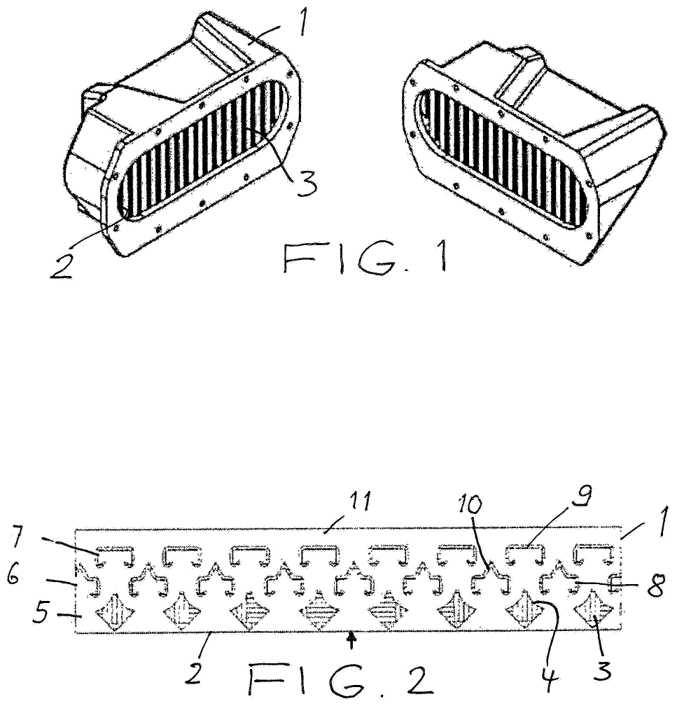

FIG. 1 shows two perspective views of a mist eliminator with a lateral inlet and horizontal through flow; and

FIG. 2 is a schematic plan view onto three levels of the functional elements of the mist eliminator.

The mist eliminator shown in FIG. 1 in two spatial views has a housing 1 whose dimensions are for instance 280 mm×140 mm×75 mm. The housing has an intake opening 2 on one side surface over which a plurality of juxtaposed and spaced flow deflection elements 3 extend vertically. A gas stream carrying liquid and/or solid particles enters the intake opening 2 in the mist eliminator and is separated from the liquid and/or the particles in the interior thereof. Then the particle-free gas stream and the liquid and/or the particles are discharged from the housing via suitable outlets (not shown here). For instance, such a mist eliminator can be downstream of a heat exchanger.

The plan view shown in FIG. 2 shows the inner construction of the mist eliminator. The arrow indicates the flow direction of the gas stream. The gas stream carrying liquid and/or solid particles enters the housing of the mist eliminator through the schematically shown openings 2 and passes at least three levels 5, 6, 7 of functional elements one after the other in the gas-flow direction.

The first level has a plurality of juxtaposed and spaced lozenge-section flow deflection elements 3 that have a pure flow deflection function and accelerate the entering gas stream. The flow deflection elements 3 that are of lozenge cross-section have two slightly concavely curved downstream faces 4 merging at a point directed along the center line of the intermediate spaces of the functional elements 8 on the second level 6. The functional elements of the second level 6 are formed as first liquid/solid particle collection and discharge elements 8. In detail, these functional elements have a box-like cross-section and a nearly completely open upstream side (flow side) for collecting the separated liquid droplets and/or particles. A ridge 10 having with an apex is formed on the downstream faces of these functional elements of the second level 6. These ridges fulfill a guiding function and guide the stream into the intermediate spaces between the functional elements of the next identical or last level 7. These functional elements are also designed as liquid/solid particle collection and discharge elements 9 and have a box-like cross-section with nearly completely open upstream sides (flow side).

The mist eliminator functions in the following manner:

The gas stream carrying liquid and/or solid particles enters the mist eliminator housing 1 through the intake opening 2. It impinges onto the rhombic-section flow deflection elements and is divided by them and fed past the open upstream sides (flow sides) into the adjacent liquid/solid particle collection and discharge elements 8 of the second level 6. Liquid droplets and/or solid particles are separated by these elements 8 and deflected downwardly in the elements 8, i.e. perpendicularly with respect to the plane of the drawing. Then the deflected gas stream is guided along the curved downstream face 4 of the flow deflection elements 3 into the intermediate space between the functional elements 8 of the second level 6 (that can be possibly be in more than one row) and impinges onto the open upstream sides (flow side) of the liquid/solid particle collection and discharge elements 9 of the third level 7. Here, a separation of further liquid droplets takes place that are then discharged downward in the elements 9. Then the deflected gas stream moves over the downstream faces of the elements 8 that form a ridge 10 provided with an apex into the intermediate spaces between the elements 9 and from there laterally toward the outlet of the gas stream stripped of the liquid.

The functional elements of the at least three levels 5, 6 and 7 are offset with respect to one another and overlap only slightly so that only a small blocking of the gas stream passing the elements occurs. This way there is only a small loss of pressure. The functional elements of the second and possibly further level 6 and last level 7 cause a separation of liquid droplets or solid particles in two successive levels so that, despite of the only slight blocking of the gas stream, a very good separation effect with a small loss of pressure is obtained. Furthermore, an especially small installation depth is taken up.

1. A mist eliminator for separating liquid and/or solid particles out of a gas stream and comprising
a housing having an inlet for the gas stream carrying liquid/solid particles and an outlet for the gas stream stripped of the liquid and/or solid particles and for the liquid and/or solid particles, and
a plurality of functional elements in a flow path of the gas stream carrying liquid/solid particles, the functional elements being offset in a flow direction in
a furthest upstream level in the flow direction includes a plurality of juxtaposed and spaced pure flow deflection elements,
at least one intermediate level having a plurality of juxtaposed and spaced first liquid/solid collection and discharge elements, and
a furthest downstream level in the flow direction having a plurality of juxtaposed and spaced further liquid/solid particle collection and discharge elements,
the functional elements of each of the different levels being spaced from one another and overlapping partly laterally with respective functional element of upstream or downstream levels, the functional elements of the upstream level as well as the first liquid/solid particle collection and discharge elements of the second intermediate level having downstream faces extending in an inclined or curved manner toward center lines of intermediate spaces between the functional elements of the next downstream level.

2. The mist eliminator according to claim 1, wherein the downstream faces of the flow deflection elements and the liquid/solid particle collection and discharge elements form a point on the center line of the intermediate spaces between the functional elements of the next level.

3. The mist eliminator according to claim 1, wherein the flow deflection elements have a rhombic cross-section.

4. The mist eliminator according to claim 1, wherein the liquid/solid particle collection and discharge elements are formed as box-like collection elements at least partly open at the upstream side.

5. The mist eliminator according to claim 1, wherein the liquid/solid particle collection and discharge elements of the second and possibly further level each have a deflection ridge on their downstream face.

6. The mist eliminator according to claim 5, wherein the deflection ridges are formed as small deflection points.

7. The mist eliminator according to claim 1, wherein a space serving for deflecting the gas stream released from liquid and/or solid particles laterally is provided in the housing downstream of the downstream level.

8. The mist eliminator according to claim 1, wherein the flow deflection elements have an opening angle of 60-120° on the upstream side.

9. The mist eliminator according to claim 1, wherein the downstream faces of the flow deflection elements are concavely curved.
